(19) United States
(12) Patent Application Publication
(10) Pub. No.: US 2008/0118284 A1
(43) Pub. Date: May 22, 2008

(54) ROLLER APPARATUS AND FIXING APPARATUS

(75) Inventors: Satoshi Kinouchi, Tokyo (JP); Yoshinori Tsueda, Shizuoka-ken (JP); Osamu Takagi, Tokyo (JP); Toshihiro Sone, Kanagawa-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/943,147

(22) Filed: Nov. 20, 2007

Related U.S. Application Data
(60) Provisional application No. 60/866,664, filed on Nov. 21, 2006.

(51) Int. Cl. G03G 15/20

(52) U.S. Cl. 399/333

(57) ABSTRACT

There is provided a technique in which in a roller apparatus including a roller constructed by inserting a core member in a cylindrical elastic body, the occurrence of disadvantages due to the reduction in bonding strength between the elastic body and the core member is suppressed by a simple structure. In the roller apparatus including a core member that rotates around a rotation axis, and a cylindrical elastic body in which the core member is inserted, at least a boundary portion between the elastic body at an end position in a direction of the rotation axis P and the core member is coated with a coating part.

### BACKGROUND OF THE INVENTION

1. Field of the Invention

The present invention relates to a roller apparatus for transporting a sheet or the like and a fixing apparatus including the same, and particularly to a technique to prevent the occurrence of a harmful effect caused by the use of a roller

2. Description of the Related Art

Hitherto, there is known a roller apparatus including a roller constructed such that a metal core rotatable around a rotation axis is inserted into a cylindrical elastic body, and the elastic body is bonded to a core member. In the roller apparatus as stated above, a material such as, for example, a sponge is adopted for the elastic body in which the core member is inserted.

In the related art roller apparatus, according to the number of times of rotation of the elastic roller and the state of a load, the bonding strength (adhesion strength) between the elastic body and the core member is reduced with time, and friction occurs between the elastic body and the core member.

There is a case where the friction phenomenon between the elastic body and the core member causes breakage (foam breaking of the sponge, or the like) of the surface of the elastic body which is in contact with the core member. The breakage of the elastic body at the contact portion between the elastic body and the core member scatters minute fragments of the elastic body from the end of the roller (see FIG. 14).

### SUMMARY OF THE INVENTION

It is an object of an embodiment of the invention to provide a technique in which in a roller apparatus including a roller constructed by inserting a core member in a cylindrical elastic body, the occurrence of disadvantages due to the reduction in bonding strength between the elastic body and the core member is suppressed by a simple structure.

In order to solve the problem, according to an aspect of the invention, a roller apparatus includes a core member that rotates around a specified rotation axis, a cylindrical elastic body in which the core member is inserted, and a coating part to coat at least a boundary portion between the elastic body at an end position in a direction of the rotation axis and the core member.

According to another aspect of the invention, a roller apparatus includes a core member that rotate around a specified rotation axis, a cylindrical elastic body in which the core member is inserted, and a reception part that is disposed below a boundary portion between the elastic body at an end position in a direction of the rotation axis and the core member and receives a fragment of the elastic body falling from the boundary portion.

Besides, according to another aspect of the invention, a fixing apparatus includes a roller apparatus according to claim 1, a roller member that is disposed to come in contact with an outer surface of an elastic body in a rotation radius direction in the roller apparatus and nips and transports a sheet in cooperation with the roller apparatus, and a heat unit to heat at least one of the elastic body of the roller apparatus and the roller member.

### DESCRIPTION OF THE DRAWINGS

FIG. 1 is a view for explaining a structure of a roller apparatus of a first embodiment of the invention, a sheet transport apparatus including the roller apparatus, and a fixing apparatus including these.

FIG. 2 is a longitudinal sectional view on a vertical surface including a rotation axis of the roller apparatus R1 of the first embodiment of the invention.

FIG. 3 is a view of an end of the roller apparatus R1 of the first embodiment of the invention seen from outside in a rotation axis direction (in an x-axis direction).

FIG. 4 is a longitudinal sectional view on a vertical surface including a rotation axis of a roller apparatus R2 of a second embodiment of the invention.

FIG. 5 is a view of an end of the roller apparatus R2 of the second embodiment of the invention seen from outside in a rotation axis direction.

FIG. 6 is a longitudinal sectional view on a vertical surface including a rotation axis of a roller apparatus R3 of a third embodiment of the invention.

FIG. 7 is a view of an end of the roller apparatus R3 of the third embodiment of the invention seen from outside in a rotation axis direction.

FIG. 8 is a longitudinal sectional view on a vertical surface including a rotation axis of a roller apparatus R4 of a fourth embodiment of the invention.

FIG. 9 is a view of an end of the roller apparatus R4 of the fourth embodiment of the invention seen from outside in a rotation axis direction.

FIG. 10 is a longitudinal sectional view on a vertical surface including a rotation axis of a roller apparatus R5 of a fifth embodiment of the invention.

FIG. 11 is a longitudinal sectional view on a vertical surface including a rotation axis of a roller apparatus R6 of a sixth embodiment of the invention.

FIG. 12 is a longitudinal sectional view on a vertical surface including a rotation axis of a roller apparatus R7 of a seventh embodiment of the invention.

FIG. 13 is a view of an end of the roller apparatus R7 of the seventh embodiment of the invention seen from outside in a rotation axis direction.

FIG. 14 is a view showing a state in which fragments of an elastic body fall from a boundary portion between an elastic body and a core member.

### DESCRIPTION OF THE EMBODIMENTS

Hereinafter, embodiments of the invention will be described with reference to the drawings.

### First Embodiment

First, a first embodiment of the invention will be described.

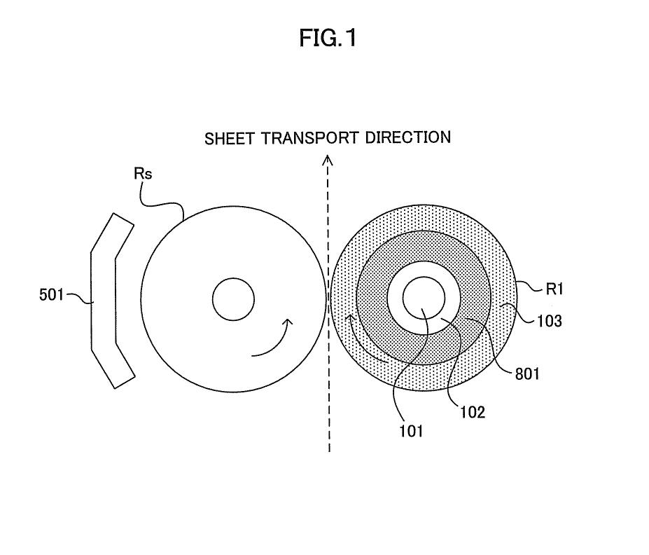

FIG. 1 is a view for explaining a structure of a roller apparatus of a first embodiment of the invention, a sheet transport apparatus including the roller apparatus, and a fixing apparatus including these. Hereinafter, in each of after-mentioned embodiments, since a different point from this embodiment is a structure of a roller apparatus, a description of a form in which a roller apparatus of each of the embodiments is included in a sheet transport apparatus and a fixing apparatus will be omitted.

As shown in FIG. 1, the fixing apparatus of the embodiment includes a roller apparatus R1, a roller member Rs, and an induction heating coil 501 (corresponding to a heat unit). The sheet transport apparatus of this embodiment includes the roller apparatus R1 and the roller member Rs.

The outer surface of an elastic body 103 in a rotation radius direction in the roller apparatus R1 and the roller surface of the roller member Rs are disposed to be in contact with each other, and the roller apparatus R1 and the roller member Rs can nip and transport a sheet in cooperation with each other.

The roller surface of the roller member Rs can be heated by the induction heating coil 501, and the sheet on which a developer image is formed is nipped and transported by the roller apparatus R1 having a role as a pressure roller and the roller member Rs having a role as a heat roller, so that the developer image is heated and fixed on the sheet.

Incidentally, in this embodiment, although the structure in which the roller apparatus R1 has the role as the pressure roller, and the roller member Rs has the role as the heat roller is used as an example, no limitation is made to this, and it is needless to say that the structure can be made such that for example, the roller apparatus R1 has the role as the heat roller and the roller member Rs has the role as the pressure roller.

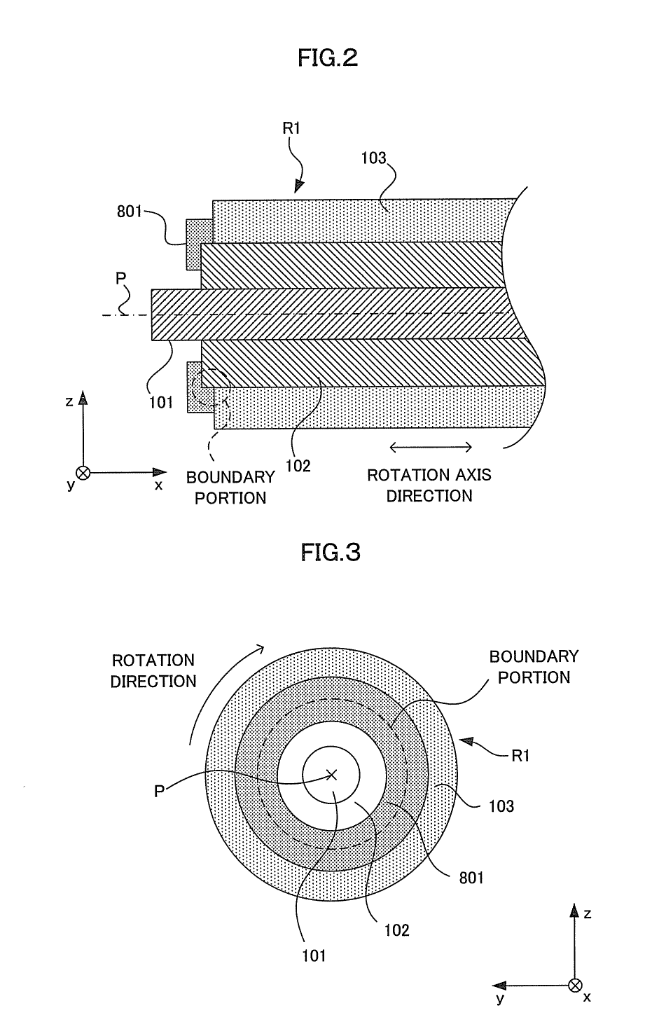

FIG. 2 is a longitudinal sectional view on a vertical surface including a rotation axis of the roller apparatus R1 of the first embodiment of the invention, and FIG. 3 is a view of the end of the roller apparatus R1 of the first embodiment of the invention seen from outside in a rotation axis direction (in an x-axis direction).

The roller apparatus R1 of this embodiment includes a shaft member 101, a core member 102, an elastic body 103, and a coating part 801.

The shaft member 101 is made of, for example, iron, stainless, aluminum or the like. The shaft member 101 has only to have a function as a shaft that rotates around a rotation axis P, and its structure may be a solid structure or a hollow structure. The shaft member 101 is supported by a not-shown bearing or the like, so that the roller formed of the elastic body 103 and the like can be rotated.

The core member 102 rotates integrally with the shaft member 101 around the rotation axis P. Here, although an example is used in which the shaft member 101 and the core member 102 are separate members, for example, the shaft member 101 and the core member 102 may be integrally formed by the same material (for example, iron, stainless, aluminum, etc.). Since the elastic body 103 is bonded to the outer peripheral surface of the core member 102, it is desirable that irrespective of whether the shaft member 101 and the core member 102 are integrated or separated, the material of the core member 102 has such a property (adhesion property etc.) that the core member is easily bonded to the elastic body 103.

The elastic body 103 is made of a material resistant to heat and having elasticity such as, for example, silicon foamed rubber. The elastic body 103 is formed into such a cylindrical shape that the core member 102 can be inserted into the center. The elastic body 103 is bonded to the inserted core member 102 by an adhesive or the like.

The coating part 801 coats at least a boundary portion (see FIG. 2) between the elastic body 103 at the end position in the rotation axis P direction and the core member 102.

The coating part 801 here is a coat layer formed of fluorine resin or silicone. Incidentally, as a material forming the coating part 801, it is desirable to adopt the same material as the material of a coating on the outer surface of the elastic body 103 in the rotation radius direction. In addition, the boundary portion may be coated and fixed by a bonding layer which can bond the elastic body 103 to the core member 102.

### Second Embodiment

Next, a second embodiment of the invention will be described.

This embodiment is a modified example of the first embodiment. This embodiment is different from the first embodiment in the structure of a coating part. Hereinafter, a portion having the same function as a portion already explained in the first embodiment is denoted by the same reference numeral and its explanation will be omitted.

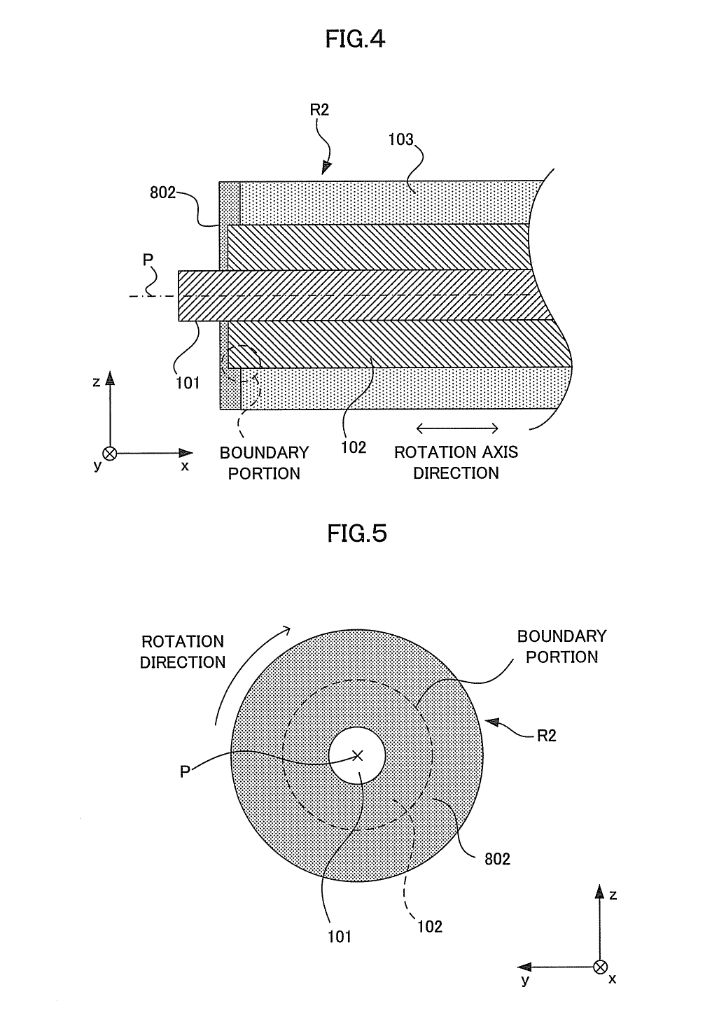

FIG. 4 is a longitudinal sectional view on a vertical surface including a rotation axis of a roller apparatus R2 of the second embodiment of the invention, and FIG. 5 is a view of an end of the roller apparatus R2 of the second embodiment of the invention seen from outside in a rotation axis direction.

As is understood from FIG. 4 and FIG. 5, a coating part 802 in the roller apparatus R2 of this embodiment is different from the coating part 801 of the first embodiment, and coats the whole end surface (except a shaft member 101) of a core member 102 and an elastic body 103 in the rotation axis direction.

As stated above, since the whole end surface including a boundary portion between the elastic body and the core member is coated, as compared with the case where only the boundary portion is coated, the falling and scattering of fragments of the elastic body can be more certainly prevented. Besides, since the end surface of the elastic body and the end surface of the core member are coated in the wide range as stated above, the elastic body can be more stably fixed to the core member.

### Third Embodiment

Next, a third embodiment of the invention will be described.

This embodiment is a modified example of the first and the second embodiment. This embodiment is different from the above respective embodiments in the structure of a coating part. Hereinafter, a portion having the same function as a portion already explained in the first and the second embodiment is denoted by the same reference numeral and its explanation will be omitted.

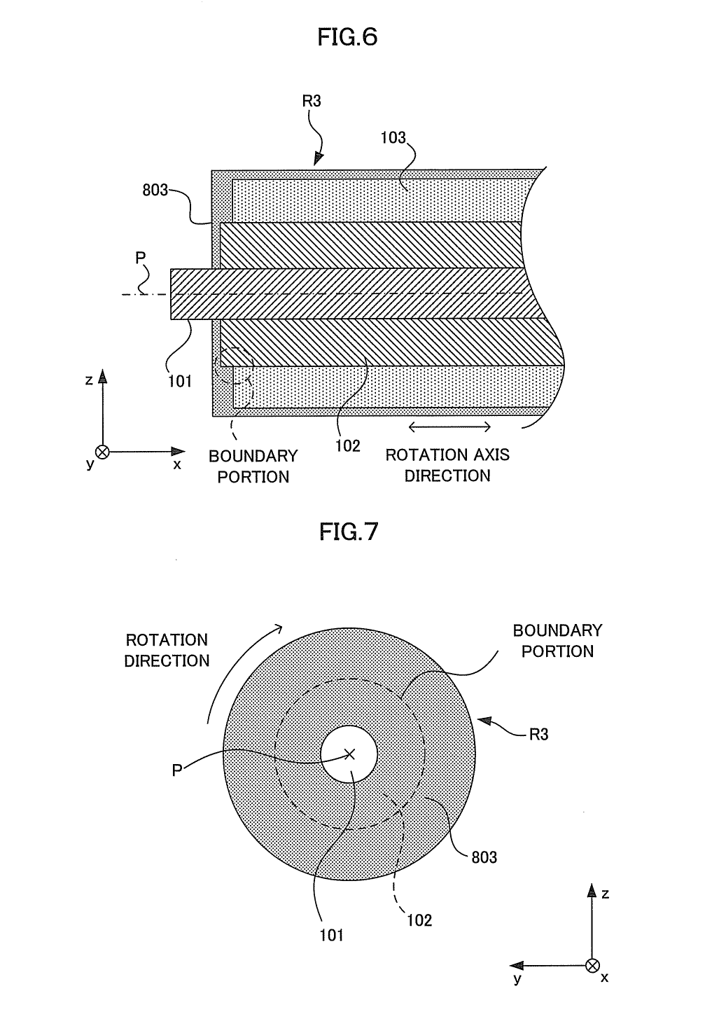

FIG. 6 is a longitudinal sectional view on a vertical surface including a rotation axis of a roller apparatus R3 of the third embodiment of the invention, and FIG. 7 is a view of an end of the roller apparatus R3 of the third embodiment of the invention seen from outside in a rotation axis direction.

As is understood from FIG. 6 and FIG. 7, a coating part 803 in the roller apparatus R3 of this embodiment coats not only the end surface of an elastic body 103 in the rotation axis direction but also the outer surface thereof in a rotation radius direction. That is, the coating part 803 coats the whole surface of the core member 102 and the elastic body 103 exposed to the outside.

Since the coating part 803 is made to have such a structure, as compared with the case where only the end surface of the elastic body 103 is coated, the deformation of the elastic body 103 to the outside in the rotation radius direction can be regulated more effectively, and the bonding strength between the elastic body 103 and the core member 102 can be kept for a long period.

### Fourth Embodiment

Next, a fourth embodiment of the invention will be described.

This embodiment is a modified example of the above respective embodiments. This embodiment is different from the above respective embodiments in the structure of a coating part. Hereinafter, a portion having the same function as a portion already explained in the above respective embodiments is denoted by the same reference numeral and its explanation will be omitted.

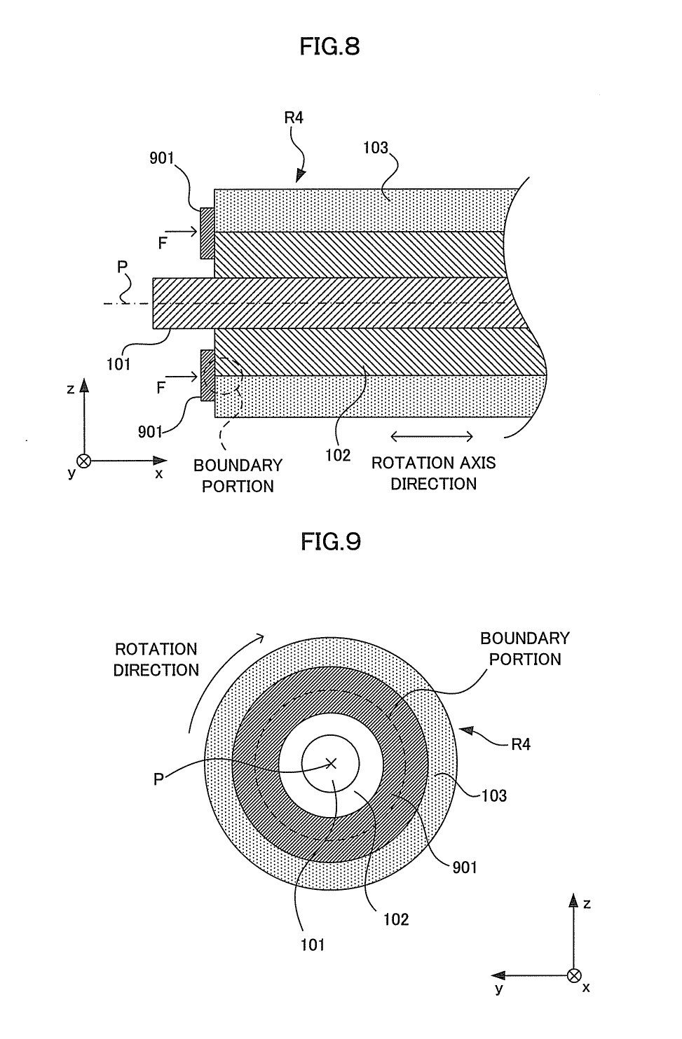

FIG. 8 is a longitudinal sectional view on a vertical surface including a rotation axis of a roller apparatus R4 of the fourth embodiment of the invention, and FIG. 9 is a view of an end of the roller apparatus R4 of the fourth embodiment of the invention seen from outside in a rotation axis direction.

As is understood from FIG. 8 and FIG. 9, a coating part 901 in the roller apparatus R4 of this embodiment is different from the coating as in the foregoing respective embodiments, and is made of a member such as ring-shaped metal washer.

In this embodiment, the ring-shaped member as stated above is bonded to at least a boundary portion between an elastic body 103 at an end position in the rotation axis direction and a core member 102, and is pressed to the boundary portion, so that the boundary portion is coated.

Besides, since the coating part having high rigidity, such as a washer, is adopted, it is prevented that fragments of the elastic body fall, and further, it is possible to effectively prevent the position shift of the elastic body relative to the core member in the case where bonding is peeled off between the elastic body and the core member.

Incidentally, the pressing of the coating part 901 to the boundary portion can be realized by, for example, pressing the coating part 901 to the end surface of the elastic body 103 by a spring or the like fixed to a shaft member 101.

### Fifth Embodiment

Next, a fifth embodiment of the invention will be described.

Hereinafter, a portion having the same function as a portion already explained in the above respective embodiments is denoted by the same reference numeral and its explanation will be omitted.

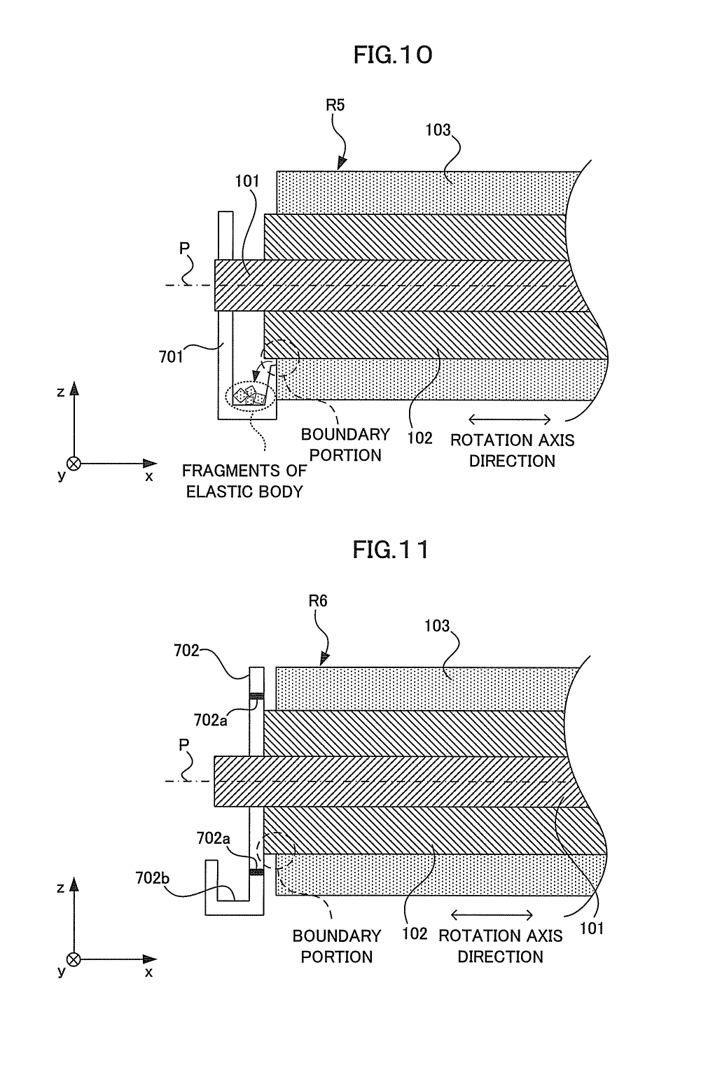

FIG. 10 is a longitudinal sectional view on a vertical surface including a rotation axis of a roller apparatus R5 of the fifth embodiment of the invention.

The roller apparatus R5 of this embodiment includes a shaft member 101, a core member 102, an elastic body 103 and a reception part 701.

The reception part 701 in this embodiment is disposed below a boundary portion between the elastic body 103 at an end position in a rotation axis direction and the core member 102, and has a role to receive fragments of the elastic body falling from the boundary portion.

Incidentally, in the reception part 701 shown in FIG. 10, although the lower end of the reception part 701 is positioned at the side of the elastic body 103, in order to collect fragments adhered to the elastic body 103 by static electricity or the like and having wound around the outer surface of the elastic body 103 in the rotation radius direction, the structure may be made such that the portion of the reception part to receive the fragments of the elastic body winds around the lower part of the elastic body 103.

By doing so, the fragments of the elastic body falling from the boundary between the elastic body and the core member can be collected by the reception part without scattering into the apparatus. By this, it is possible to suppress the occurrence of a bad influence (erroneous operation or the like due to the mixture of fragments into another unit) due to the scattering of the fragments of the elastic body.

### Sixth Embodiment

Next, a sixth embodiment of the invention will be described.

This embodiment is a modified example of the fifth embodiment. Hereinafter, a portion having the same function as a portion already explained in the above fifth embodiment is denoted by the same reference numeral and its explanation will be omitted.

FIG. 11 is a longitudinal sectional view on a vertical surface including a rotation axis of a roller apparatus R6 of the sixth embodiment.

The roller apparatus R6 of this embodiment includes a shaft member 101, a core member 102, an elastic body 103 and a regulation member 702.

The regulation member 702 of this embodiment is provided in the vicinity of the end position of the elastic body 103 in a rotation axis direction, and has a role to regulate a position shift of the elastic body 103 from the core member 102 in the rotation axis direction.

A substantially C-shaped reception part 702b is provided to be extended at the lower end of the regulation member 702. A hole 702a is formed at a portion of the regulation member 702 corresponding to a boundary portion between the elastic body 103 and the core member 102. The reception part 702b is disposed below the boundary portion between the elastic body 103 and the core member 102, and collects fragments of the elastic body 103 which are produced at the boundary portion and fall through the hole 702a.

As stated above, since the reception part 702b is provided to be extended at the lower end of the regulation member 702 (the regulation member 702 and the reception part 702b are integrally formed), the number of parts can be reduced, and this can contribute to space saving of the whole apparatus and cost reduction.

Of course, it is not always necessary to form the reception part integrally with the regulation member to regulate the position shift of the elastic body. For example, in the case where a belt is wound around the elastic body 103, a meandering regulating plate (so-called leaning stop) for regulating the position shift of the belt in the rotation axis P direction and the reception part may be integrally formed.

### Seventh Embodiment

Next, a seventh embodiment of the invention will be described.

This embodiment is a modified example of the sixth embodiment. Hereinafter, a portion having the same function as a portion already explained in the above sixth embodiment is denoted by the same reference numeral and its explanation will be omitted. This embodiment is different from the sixth embodiment in the structure of a hole part provided in a regulation member.

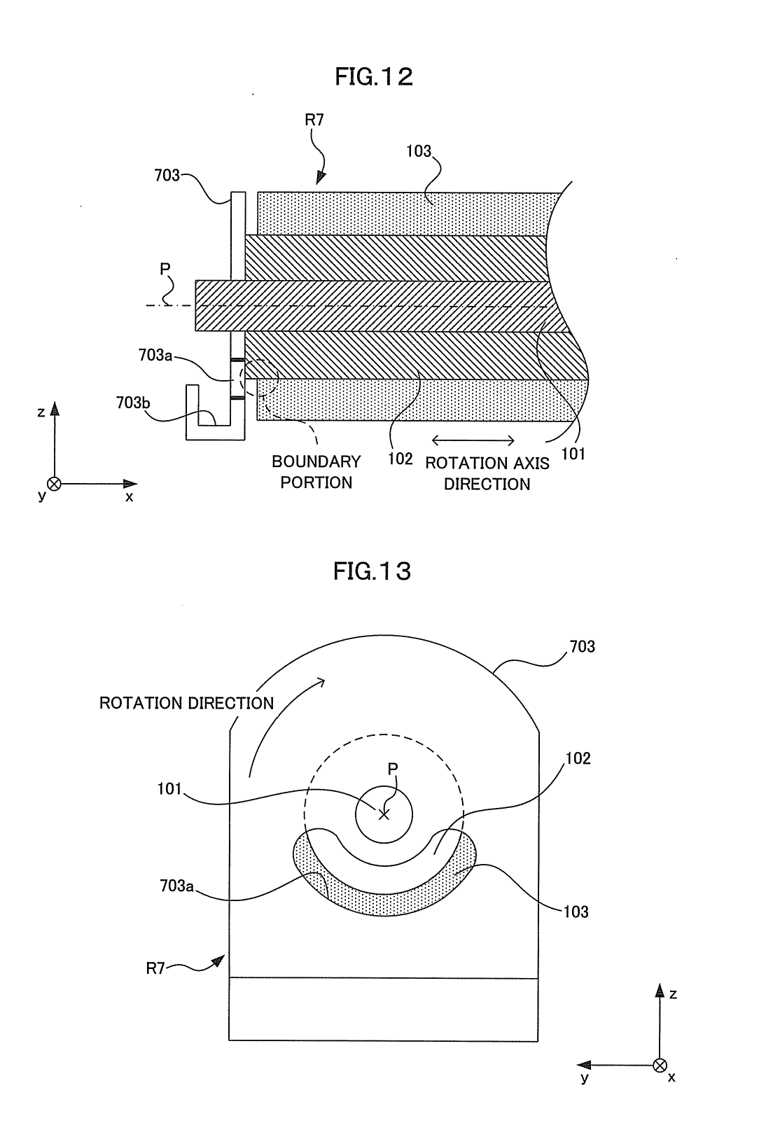

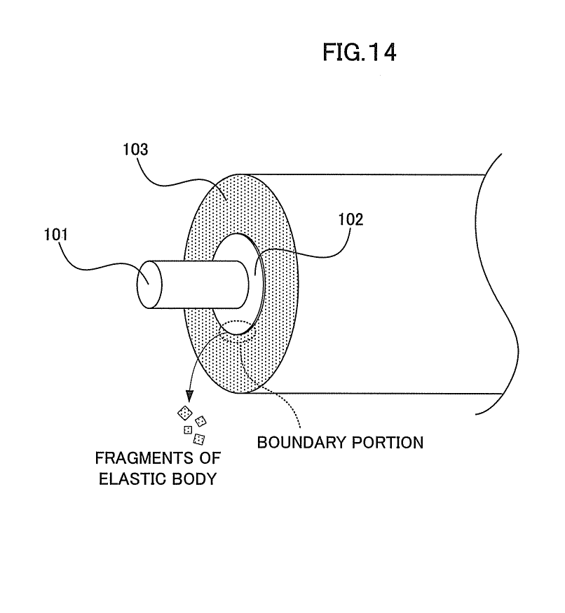

FIG. 12 is a longitudinal sectional view on a vertical surface including a rotation axis of a roller apparatus R7 of the seventh embodiment of the invention, and FIG. 13 is a view of an end of the roller apparatus R7 of the seventh embodiment of the invention seen from outside in a rotation axis direction.

The roller apparatus R7 of this embodiment includes a shaft member 101, a core member 102, an elastic body 103 and a regulation member 703.

Similarly to the regulation member 702 of the sixth embodiment, the regulation member 703 in this embodiment is provided in the vicinity of the end position of the elastic body 103 in the rotation axis direction, and has a role to regulate the position shift of the elastic body 103 from the core member 102 in the rotation axis direction. Besides, a substantially C-shaped reception part 703b is provided to be extended at the lower end of the regulation member 703.

Further, the regulation member 703 is provided with a hole part 703a to guide fragments of the elastic body falling from a boundary portion corresponding to a range positioned below a rotation axis P in a boundary portion between the elastic body 103 at the end position in the rotation axis direction and the core member 102.

In general, the core member is held by a bearing or the like and is rotatable. Thus, in the case where the bearing is disposed at a position close to the end surface of the elastic body, there is a fear that fragments of the elastic body fall, enters the bearing, and exerts a bad influence.

Then, it is desirable that the hole part to guide the fragments to the reception part is provided below the rotation axis so that the fragments do not fall to the bearing side from at least the boundary portion between the elastic body and the core member positioned above the rotation axis.

Incidentally, in this embodiment, although the example has been described in which the shape of the hole part 703a is symmetrical, no limitation is made to this. For example, in the case where the rotation speed of the roller in the roller apparatus is high, fragments of the elastic body do not necessarily fall directly below. Thus, the roller rotation speed and the like are also considered, and the hole part may be formed to have an asymmetrical shape (for example, the width of the hole at the downstream side in the rotation direction becomes wide).

Besides, in order to prevent the fragments of the elastic body from falling to the periphery of the shaft member 101, a cover member to cover the upper part of the shaft member 101 is provided, and the mixture of fragments of the elastic body into the bearing or the like may be prevented.

In addition, an optical sensor is disposed in the vicinity of the boundary portion between the elastic body and the core member, and the quantity of fragments of the elastic body falling from the boundary portion may be detected. Specifically, a reception part to collect the fragments of the elastic body falling from the boundary portion is provided, and the fragments accumulated in this reception part are detected based on the amount of reflection of infrared rays or light of a normal wavelength. Then, in the case where the fragments of the elastic body are detected, an error notification is made to the user by a not-shown display or speaker.

In general, when the fragment of the elastic body starts to fall from the boundary portion, thereafter, there is a high possibility that the elastic body is shifted from the core member, or the elastic body is damaged. Thus, the fragment of the elastic body falling from the boundary portion is detected, and the disadvantage which can occur in future in the elastic body is previously estimated, and before an influence is exerted on a sheet transport process or a fixing process, the user's attention can be drawn to the necessity of maintenance.

In addition, a structure can be made such that in order to early detect the disadvantage of the elastic body, a switch is provided at a specified position (such a position that even if the elastic body is shifted at least to the position, the roller apparatus can normally function) in the vicinity of the end of the elastic body in the rotation axis direction, and when the elastic body starts to shift with respect to the core member, the end surface of the elastic body is brought into contact with the switch, so that the disadvantage occurring in the elastic body is notified to the user at an early stage. Of course, the reception part adopted in the fifth to the seventh embodiment is constructed integrally with the switch mechanism, and the space saving and the reduction in the number of parts may be realized.

In addition, it is needless to say that an image forming apparatus (MFP: Multi Function Peripheral) including one of the roller apparatus, the sheet transport apparatus and the fixing apparatus described in the foregoing respective embodiments can be provided.

Although the invention has been described by use of the specific mode, it would be apparent for one of ordinary skill in the art that various modifications and improvements can be made without departing from the sprit and the scope of the invention.

As described above in detail, according to the invention, in the roller apparatus including the roller constructed by inserting the core member in the cylindrical elastic body, the technique to suppress the occurrence of disadvantages due to the reduction in bonding strength between the elastic body and the core member can be provided by the simple structure.

What is claimed is:

1. A roller apparatus comprising:
a core member that rotates around a rotation axis;
a cylindrical elastic body in which the core member is inserted; and
a coating part to coat at least a boundary portion between the elastic body at an end position in a direction of the rotation axis and the core member.

2. The roller apparatus according to claim 1, wherein the coating part coats the boundary portion by pressing a ring-shaped member to at least the boundary portion between the elastic body at the end position in the direction of the rotation axis and the core member.

3. The roller apparatus according to claim 1, wherein the coating part coats a whole end surface of the core member and the elastic body in the direction of the rotation axis.

4. The roller apparatus according to claim 3, wherein the coating part further coats an outer surface of the elastic body in a rotation radius direction.

5. A roller apparatus comprising:
a core member that rotates around a rotation axis;
a cylindrical elastic body in which the core member is inserted; and
a reception part that is disposed below a boundary portion between the elastic body at an end position in a direction of the rotation axis and the core member and receives a fragment of the elastic body falling from the boundary portion.

6. The roller apparatus according to claim 5, further comprising a regulation member that is disposed at the end position of the elastic body in the direction of the rotation axis and regulates a position shift of the elastic body from the core member in the direction of the rotation axis,
wherein the reception part is formed integrally with the regulation member.

7. The roller apparatus according to claim 6, wherein the regulation member includes a hole part to guide, to the reception part, the fragment of the elastic body falling from the boundary portion corresponding to a range positioned below the rotation axis in the boundary portion between the elastic body at the end position in the direction of the rotation axis and the core member.

8. A fixing apparatus comprising:
a roller apparatus according to claim 1;
a roller member that is disposed to come in contact with an outer surface of an elastic body in a rotation radius direction in the roller apparatus, and nips and transports a sheet in cooperation with the roller apparatus; and
a heat unit to heat at least one of the elastic body of the roller apparatus and the roller member.

9. The fixing apparatus according to claim 8, wherein the coating part coats the boundary portion by pressing a ring-shaped member to at least the boundary portion between the elastic body at the end position in the direction of the rotation axis and the core member.

10. The fixing apparatus according to claim 8, wherein the coating part coats a whole end surface of the core member and the elastic body in the direction of the rotation axis.

11. The fixing apparatus according to claim 10, wherein the coating part further coats an outer surface of the elastic body in a rotation radius direction.
